(19) United States
(12) Patent Application Publication
(10) Pub. No.: US 2018/0240299 A1
(43) Pub. Date: Aug. 23, 2018

(54) GAMING METHODS AND DEVICES

(71) Applicant: Richard Grellner, Oklahoma City, OK (US)

(72) Inventor: Richard Grellner, Oklahoma City, OK (US)

(21) Appl. No.: 15/962,328

(22) Filed: Apr. 25, 2018

Related U.S. Application Data
(63) Continuation of application No. 10/623,217, filed on Jul. 18, 2003.
(60) Provisional application No. 60/397,146, filed on Jul. 19, 2002.

(51) Int. Cl. G07F 17/32

(52) U.S. Cl. CPC G07F 17/3223; G07F 17/3244

(57) ABSTRACT

The present invention provides methods and devices of engaging in which a human non-player selects one of a plurality of cards by performing a manual operation of chance. Information about an outcome of the selected card is then introduced into an electronic communication channel for depiction of an image to a player. A further aspect includes a human proxy that performs at least some functions that are typically performed by an active player. The present invention is also directed toward methods and devices for increasing the speed of games in which a human non-player makes a selection by a manual operation of chance. A further aspect includes methods of converting what would otherwise be classified as class III games into class II games by overtly inserting a human non-player into the game to make a manual selection of a ticket (used interchangeably with the terms “card” and “tab” throughout) from a storage device. A further aspect includes methods of converting what would otherwise be a slot machine or gambling device off Indian lands into a legal class II like game by inserting a human non-play into the game to make the manual selection of a ticket.

This application is a continuation of pending U.S. application Ser. No. 10/623217, filed Jul. 18, 2003, which claims the benefit of U.S. provisional application No. 60/397146, filed Jul. 19, 2002, which is incorporated herein by reference in its entirety.

### FIELD OF THE INVENTION

The field of the invention is gaming.

### BACKGROUND OF THE INVENTION

The classes of gaming on Indian lands have been defined by Congress through the Indian Gaming Regulatory Act of 1988 (“IGRA”). Under another law sometimes applicable, the Johnson Act, the use or possession of gambling devices in Indian country is prohibited; gaming sanctioned under IGRA has been viewed by the courts as not being in violation of the Johnson Act. Under IGRA, Class II gaming is regulated in part by a federal agency, the National Indian Gaming Commission (“NIGC”). Enforcement under the Johnson Act and for certain violations of IGRA are within the jurisdiction of the Department of Justice.

Gaming that occurs on Indian lands can be divided into three classes. Class I generally covers traditional Native American games, class II covers bingo, pull-tabs, lotto, punchboards, tip jars, instant bingo, and other similar games, and certain non-banked card games, and class III covers all other games including casino games and slot machines.

Under IGRA, a tribal-state compact is generally required for class III gaming thereby making class III games more difficult to obtain sanction by appropriate jurisdictions because class III games may require at least some cooperation by the applicable state. Some states impose limits on the type of class III gaming that the states will allow. It is thus important to be able to properly classify games and in some states to create games that do not fall into class III.

A portion of IGRA, codified at 25 U.S.C. § 2703, defines class II games in the negative as follows: “the term ‘class II gaming’ does not include . . . electronic or As part of a proper determination of a class II game, it should be considered whether the game is an electronic or electromechanical facsimile of a game of chance or a slot machine of any type”. In NIGC regulations, interpretations by the Department of Justice, and court cases, including the recent case of United States v. Santee Sioux Tribe of Nebraska, 324 F. 3d 607 (8th Cir. 2003), the suggestion has been that a facsimile is defined in part as technology that replicates all of the underlying characteristics of a game.

Gaming off Indian lands includes bingo and related games falling with the definition of class II type games under IGRA but that are offered by charitable and other entities within the jurisdiction of state laws. The laws in a number of states prohibit the use variously of “slot machines” or “gambling devices” which are often defined as devices incorporating an application of an element of chance. It is thus important in some states to be able to create class II-like games that use methods and devices that do not incorporate an element of chance.

The inventor takes these and other relevant laws to mean that the application of chance must be removed from other aspects of a game in order to avoid a class III classification under IGRA, or designation of a slot machine or gambling device off of Indian lands. As a matter of practical importance, the method of applying the chance in the play of a game must be of short duration to maximize the player's enjoyment and entertainment. Additionally, the method must provide for the display of outcomes or game results to the player in a variety of entertaining formats including a display appearing to the human player as a series of reels, symbols, or numbers, or such as the outcome of a horse or automobile or other race or contest.

U.S. Pat. Nos. 5,830,067 and 63,036,038 both to Graves et al. teach a proxy device that purchases chances, plays chances, and reports results to clients who are not present at the site where the game takes place. According to the patents, the device enables individuals to participate in games of chance even though they may be outside of the jurisdiction where such games are permitted. These patents may have partially attenuated the application of chance, however, since the proxy was an automated device, it is doubtful that the device would be considered a class II game.

U.S. Pat. No. 5,857,911 to Fioretti teaches a bingo game in which the number selection is remote from players playing the game. Based on the holding in United States v. 162 MegaMania Gambling Devices, 231 F.3d 713, live call bingo played over an electronic network is a class II game. While the teachings of Fioretti may segregate an aspect of the application of chance from the players, it is important to note that a bingo card does not have a predetermined value. The teachings of Fioretti also do not teach an efficient means for the number selection.

A particular game that does have a card with a predetermined value is pull tab. U.S. Pat. Nos. 5,749,784 and 5,609,337, both to Clapper, teach an electronic gaming apparatus which contains a roll of physical pull tabs. In these games, there is a card with a predetermined value, however, the application of chance is not removed from other aspects of the game.

In U.S. Patent application 20020082070, Macke et al. teaches a ticket manufacturing device that creates populations of virtual tickets for use in a gaming environment. The ticket populations are recorded on removable, updateable cartridges. Macke contemplates that he has disclosed a class II game. However, it is clear from the '070 application that an application of chance exists within the game—that is, when the player selects a ticket from the dispenser.

Thus, there is a need for additional games that meet a class II gaming classification under IGRA or which are sanctioned off Indian lands by state laws.

### SUMMARY OF THE INVENTION

The present invention provides games and methods of engaging in class II type games including bingo, lotto, pull-tabs, instant bingo, punch boards, tip jars, and other similar games, both on and off Indian lands. A storage device is provided having a plurality of cards, each card having at least a partial predetermined value. A human non-player selects one of the plurality of cards by performing a manual operation of chance. Additionally, information about an outcome of the selected card is introduced into an electronic communication channel. In a preferred embodiment, an image is depicted to the player, such image communicating information about an outcome in the game. A further aspect includes a human proxy that performs at least some functions that are typically performed by an active player.

The present invention is also directed toward methods in which a plurality of sets are determined, each set having at least one member (e.g. a bingo ball). A human non-player then selects at least one of the sets by a manual operation of chance and the human non-player introduces information about the game outcome into an electronic communication system.

In another aspect, an integrated game of chance begins when a human non-player selects a card by a manual operation of chance. The human non-player subsequently introduces information about an outcome of the card into a communication system for display to a player.

Yet a further aspect includes methods of converting what would otherwise be classified as class III games into class II games by overtly inserting a human non-player into the game to make a manual selection of a ticket (used interchangeably with the terms “card” and “tab” throughout) from a storage device. Such aspect includes methods of converting what would otherwise be a slot machine or gambling device off Indian lands under state law into a legal class II like game.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a schematic of a prior art game.

FIG. 2 is a schematic of a method of engaging in a game of chance.

FIG. 3 is a flow chart of a method of engaging in a game of chance.

FIG. 4 is a schematic of a game having a human non-player and selection by set.

### DETAILED DESCRIPTION

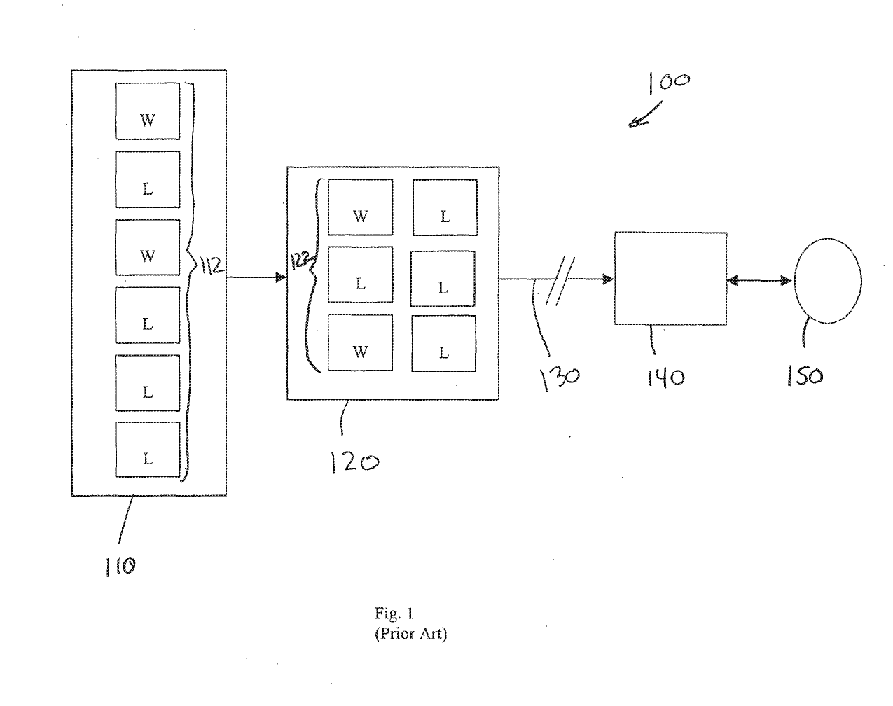

Referring first to FIG. 1, a prior art game 100 generally includes a removable, updateable cartridge 110, a card dispenser 120, a communication channel 130, a game terminal 140, and a human player 150. The cartridge 110 contains a series of virtual tickets (a population of outcomes) having predetermined value indicated here for simplicity purposes as a “W” or “L” representing a win or loss. The cartridge 110 is inserted into a card dispenser 120 “at another location”. It is important to note that a card dispenser has certain characteristics. A dispenser holds tickets for subsequent distribution when consideration is received. The amount of time that the dispenser holds the tickets is greater than the time needed to communicate the ticket. In other words the amount of time that a dispenser holds tickets is greater than the latency time (i.e. greater than the time that elapses between a stimulus and the response). Another aspect of a dispenser is that consideration flows through the communication channel 130 to the dispenser 120.

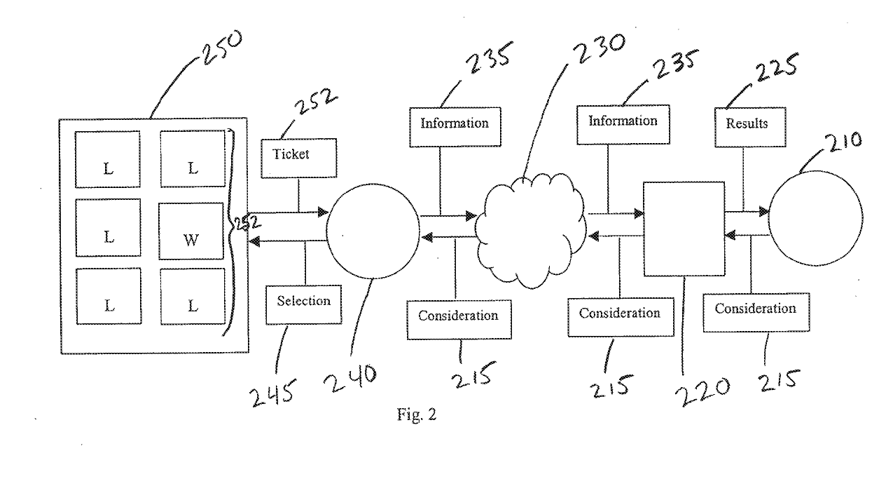

FIG. 2 depicts a method of engaging in a game of chance which generally begins when a human player 210 makes a request for ticket 215 by making an entry into a display device 220. It should be appreciated that a request for a ticket typically manifests itself as consideration, but it should be appreciated that consideration is not a requirement. In any case, it is contemplated that the request 215 can be made in any appropriate manner including using a keyboard, a smart card, inserting money, using a cell phone, using a PDA, touching the display screen, actuating a mouse, and so on.

A ticket request 215 traverses a communications path through the Internet 230 (or any other electronic network) to a human non-player 240. A path to a human non-player can include passage of the request by packet(s) through routers and can include both wireless and wired channels. An important aspect of the communication of a request through an electronic communications channel is that the request is in transit until it is received by the non-player. Receipt by the non-player means arrival of the request at the non-player's computer or other device capable of storing the electronic request. Preferably, a non-player receives tickets from a plurality of remote, unknown players. “Remote, unknown” as used in “remote, unknown player” means that player is distal (e.g. at a separate physical location) and that the player is not physically recognizable by the non-player. While there may be recognition of a player by his address, such recognition is not a physical recognition.

For purposes herein, a non-player is a human, but not the same human that requests the ticket or receives a prize or results of the ticket. The non-player can perform various tasks including making a request for a ticket by a manual operation of chance. The manual operation of chance is some physical movement such as touching a screen, moving a mouse, making an entry using a keyboard, and even reaching into a bin or some other type of storage device and grabbing a ticket. At this juncture, a distinction should be made between virtual tickets and tangible (i.e. physical) tickets. A virtual ticket is in an electronic format and therefore can reside on an electronic storage medium (hard disks, floppy, optical disk, ram, rom, eprom, etc). It is contemplated that a tangible ticket can reside on a cartridge (in a roll) or in various other configurations. In addition to the physical movement, a manual operation of chance includes an element of chance. Additionally, selection of a ticket 245 by the non- player may optionally include the step of paying consideration using any of the known methods of paying for an item (credit card, debit card, electronic transfer, etc . . . ).

After selection 245 of a ticket, the ticket 252 is received by the non-player. The non-player preferably reveals the outcome of the ticket and thereafter may introduce information 235 about the outcome of the ticket into the electronic communication channel. The information 235 may include at least one symbol or designation indicating a class of prize, a designation (i.e. address) of the intended recipient, and an amount of prize. Such information will generally be packetized and directed to the player's IP address. Ultimately, the information 235 is received at the player terminal 220. In a preferred class of embodiments, the information is processed in order to depict an image to the player. The image informs the player about the outcome of the ticket through use of text, graphics, sound, and/or video. An alternative class of embodiments includes substantially real time transfer of actual tickets from the non-player to the player.

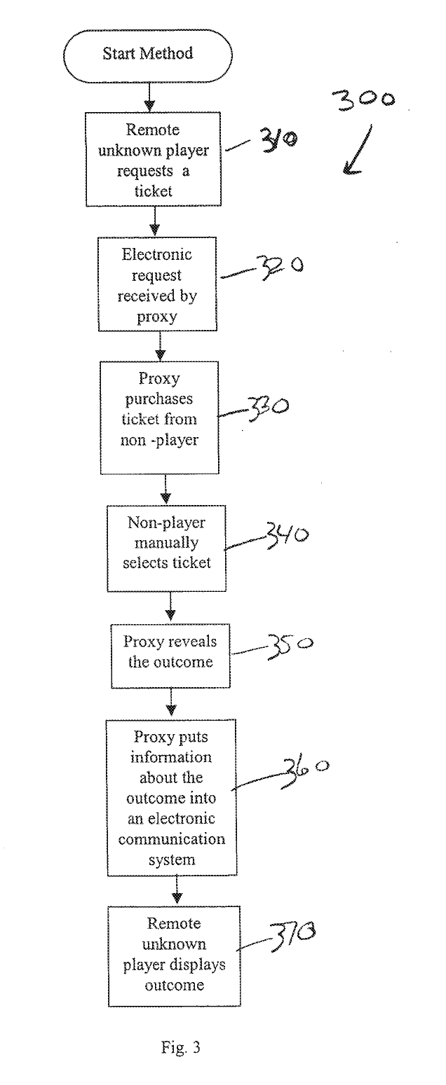

Turning now to FIG. 3, a method of engaging in a game of chance having a proxy player 300 includes steps 310-370. In the first depicted step 310 a remote, unknown player requests a ticket. As above, the request may be accompanied by or represented as consideration. Despite the inclusion of consideration, the request traverses an electronic communication channel until it is received by a proxy, step 320. In this method there is a third human -the proxy. Among the functions of a proxy may be purchasing tickets, revealing outcomes, and claiming prizes. As in step 330, the proxy purchases a ticket from the non-player. Again, a non-player selects a ticket by a manual operation of chance 340. Selection of the ticket is advantageously followed by revealing of the ticket outcome which is preferably performed by the proxy 350. Next, the proxy puts information about the outcome of the ticket into an electronic communication system 360 for display to the remote, unknown player 370. Again, other embodiments may include transfer of actual tickets rather than information about the outcome of the ticket.

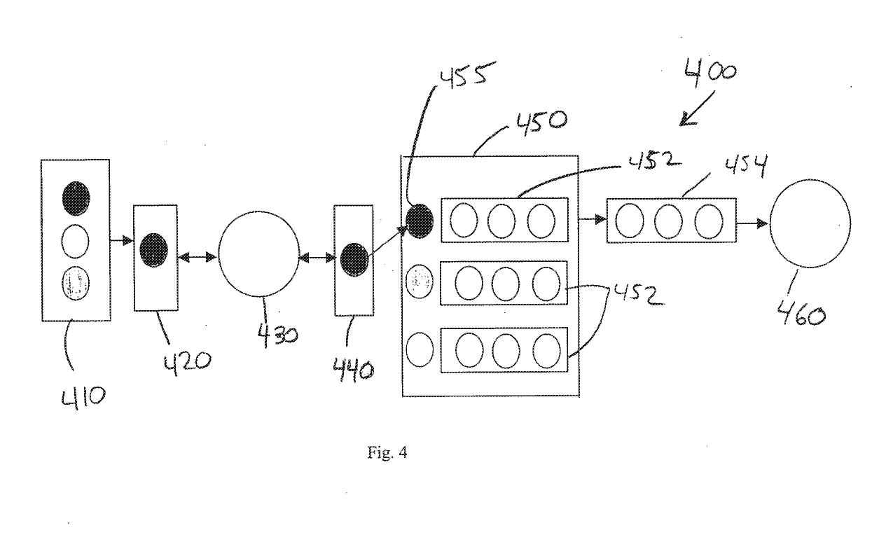

FIG. 4 shows a schematic of a game 400 generally comprising a blower 410, a selected ball 420, a human non-player 430, information about the selected ball 440, a storage device 450, and a human player 460.

Methods and devices exemplified by FIG. 4 allow for more rapid play by predetermining a plurality of sets of balls and using a blower to pick a single ball that is associated with one of the sets of balls. Thus, selection of a single ball leads to prompt introduction of a plurality of balls. This method can be repeated for a subsequent set of balls. The same can be said for selection of tickets, which can be substituted for balls in the following description.

Storage device 450 is preferably an electronic storage device having a plurality of predetermined sets 452, each set having at least one member and each member having at least one game symbol. In the context of bingo, each set contains a plurality of bingo balls with each ball having a bingo symbol such as “B3”. Each set has a unique identifier 455 associated with it. “Predetermined” as used in “predetermined sets” means that the sets are selected prior to a player paying compensation or requesting a card. Selection of the predetermined sets 452 is preferably accomplished using a random number generator or some other relatively indiscriminate method.

Once the predetermined sets and unique identifiers have been established, the human non-player 430 requests the blower 410 to blow a single ball or otherwise makes a random choice of one of the unique identifiers. The human non-player 430 inputs information 440 about the selection which is matched to the unique identifier 455 associated with one (or more) of the sets. In essence, the human inputs information that determines which of the sets is selected for play.

Once a set (or sets) has been selected, information 454 about the selected set is introduced by the human non-player into an electronic communications channel. The information 454. is displayed to the player for use in playing the game. For example, a set containing “B3”, “GS” and “N2” may be transmitted to a player although only one unique identifier has been blown by the blower—that is, selected by a manual operation of chance. A less preferred embodiment includes transfer of physical sets (e.g. of balls) instead of transfer of information about the set.

In another class of embodiments, a game of chance comprises a human non-player that selects a card by a manual operation of chance and introduces information about an outcome of that card into an electronic communication system for display to a player. In preferred embodiments, players are located remote from the non-player and players are unknown to the non-player.

Methods of converting a class III game as defined by the Indian Gaming Regulatory Act (IGRA) into a class II game as defined by the IGRA include an overt step of recognizing that insertion of_a human non-player for manual selection of a ticket from a storage device converts the game into a class II. An alternative method envisages play off Indian lands. An overt step is one taken purposely to achieve a certain result. The step of inserting a human non-player to make a manual selection of chance effectively removes the element of chance from the game.

Thus, specific embodiments and applications of gaming methods and devices have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A method of a player engaging in a “Class II gaming” game of chance under 25 U.S.C. 4 2703(6)(B) that is based upon a plurality of predetermined indicator sets, comprising:
providing a storage device that contains the plurality of predetermined indicator sets, wherein each indicator set enables a corresponding game of chance; and
during the game of chance, a human non-player selecting an indicator from one of the plurality of predetermined indicator sets by a manual operation of chance that is based upon the corresponding game of chance, and introducing information about an outcome of the selected indicator into an electronic communication channel in a manner that can be used by the player.

2. The method of claim 1, further comprising the human non-player determining the set from which the selected indicator is selected by the manual operation of chance.

3. The method of claim 2, further comprising the player requesting the selecting step using the electronic communications channel.

4. The method of claim 1, wherein at least one of the predetermined indicator sets comprises pull tabs.

5. The method of claim 1, wherein at least one of the predetermined indicator sets comprises a punch board.

6. The method of claim 1, wherein at least one of the predetermined indicator sets resides in the storage device in a non-electronic form.

7. The method of claim 1, wherein the player is remote and unknown to the human non-player, and further comprising a human proxy, different from the human non-player, receiving a request for the selecting step from the player.

8. The method of claim 7, wherein the request is communicated using the electronic communications channel.

9. The method of claim 8, further comprising the human proxy purchasing the one selected indicator as a function of the request.

10. The method of claim 9, further comprising the human proxy revealing the outcome to the player.

11. The method of claim 10, further comprising the human proxy claiming a prize corresponding to a predetermined value associated with the selected indicator.

12. The method of claim 11, wherein the selected indicator has a predetermined value.
